(19) United States
(12) Patent Application Publication
(10) Pub. No.: US 2024/0348094 A1
(43) Pub. Date: Oct. 17, 2024

(54) COUNTERTOP FREE-POSITIONING WIRELESS CHARGING DEVICE

(71) Applicant: AIRA, INC., Phoenix, AZ (US)

(72) Inventors: Jake Slatnick, Scottsdale, AZ (US); Jawad Ahsan, Paradise Valley, AZ (US); Aleksandar Petrovic, Phoenix, AZ (US); Frank Schwab, Phoenix, AZ (US)

(21) Appl. No.: 18/630,661

(22) Filed: Apr. 9, 2024

Related U.S. Application Data
(60) Provisional application No. 63/458,930, filed on Apr. 12, 2023.
(60) Provisional application No. 63/555,880, filed on Feb. 20, 2024.

(51) Int. Cl. H02J 50/00; F21S 10/02; F21V 33/00; F21W 131/301; H02J 50/10; H02J 50/40; H02J 50/90

(52) U.S. Cl. CPC H02J 50/005; F21V 33/0012; H02J 50/10; H02J 50/402; F21S 10/02; F21W 2131/301; H02J 50/90

(57) ABSTRACT

A charging system includes a wireless charging device and is embedded in or attached to a countertop, table, desk, workbench, bar top, kitchen worksurface, or other item of furniture. The wireless charging device includes a plurality of transmitting coils, at least one light source and a controller. The plurality of transmitting coils is arranged in a pattern that defines the area or limits of a charging surface located within an upper surface of a countertop. Each light source may be provided below the countertop and may be configured to illuminate an indicator line that identifies a physical location of the charging surface. The indicator line appears on the upper surface of the countertop.

### PRIORITY CLAIM

This application claims priority to and the benefit of provisional patent application No. 63/458,930 filed in the United States Patent Office on Apr. 12, 2023, and provisional patent application No. 63/555,880 filed in the United States Patent Office on Feb. 20, 2024, the entire content of these applications being incorporated herein by reference as if fully set forth below in its entirety and for all applicable purposes.

### TECHNICAL FIELD

The present invention relates generally to charging surfaces for wireless charging of batteries, including batteries in mobile computing devices and more particularly to a charging surface embedded in a countertop, table or other surface.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to provide flexibility in charging configurations and support continually increasing complexity of mobile devices and changing form factors.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates the arrangement of power transfer areas provided by a charging surface that employs multiple layers of charging cells configured in accordance with certain aspects disclosed herein.

FIG. 4 illustrates a wireless transmitter that may be provided in a charger base station in accordance with certain aspects disclosed herein.

FIG. 5 illustrates a first topology that supports matrix multiplexed switching for use in a wireless charging device adapted in accordance with certain aspects disclosed herein.

FIG. 6 illustrates a second topology that supports direct current drive in a wireless charging device adapted in accordance with certain aspects disclosed herein.

FIG. 7 illustrates an example in which a modular charging surface can be formed in accordance with certain aspects disclosed herein.

FIG. 8 illustrates an example of a Litz transmitting coil configured in accordance with certain aspects of this disclosure.

FIG. 9 illustrates an example of a portion of a charging surface provided using multiple overlapping Litz coils in accordance with certain aspects of this disclosure.

FIG. 10 illustrates a charging assembly in a wireless charging device constructed from Litz coils 800 according to certain aspects of this disclosure.

FIG. 11 illustrates certain aspects of a Litz coil substrate provided in accordance with certain aspects of this disclosure.

FIG. 12 illustrates an example of a charging system that includes multiple charging devices provided in accordance with certain aspects of this disclosure.

FIG. 13 illustrates a first example of a combined control circuit in a modular charging surface provided in accordance with certain aspects disclosed herein.

FIG. 14 illustrates a second example of a combined control circuit that may be provided in a modular charging surface provided according to certain aspects disclosed herein.

FIG. 15 illustrates the use of modular charging devices to provide one or more charging surfaces on an item of furniture in accordance with certain aspects of this disclosure.

FIG. 16 illustrates an example of a modular charging device layout on a surface in accordance with certain aspects of this disclosure.

FIG. 17 illustrates the positioning of light sources below the surface of a countertop that includes a charging surface in accordance with certain aspects of this disclosure.

FIG. 18 illustrates one example of an apparatus employing a processing circuit that may be adapted according to certain aspects disclosed herein.

FIG. 19 is flowchart illustrating an example of a method for wireless charging according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of a wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

Certain aspects of the present disclosure relate to systems, apparatus and methods for a wireless charging system that provide multiple power transmitting coils in elements of a modular or distributed surface. The coils may be stacked and can be used to charge target devices presented to the wireless charging systems without a requirement to match a particular geometry or location within a charging surface of the charging device. Each coil may have a shape that is substantially polygonal. In one example, each coil may have a hexagonal shape. Each coil may be implemented using wires, printed circuit board traces and/or other connectors that are provided in a spiral. In one example, the coils coil may be implemented using Litz wires. Each coil may span two or more layers separated by an insulator or substrate such that coils in different layers are centered around a common axis.

According to certain aspects disclosed herein, devices placed on a charging surface provided by the wireless charging system may receive power that is wirelessly transmitted through one or more of the charging cells that are associated with the charging surface. Power can be wirelessly transferred to a receiving device located anywhere on the charging surface. The receiving device can have an arbitrarily defined size and/or shape and may be placed without regard to any discrete placement locations enabled for charging. Multiple devices can be simultaneously or concurrently charged on a single surface. The apparatus can track motion of one or more devices across the surface. A charging system may provide multiple charging surface portions that are physically separated from one another but managed as a single modular charging surface that can manage and control simultaneously charging of multiple devices. The charging system may be manufactured at low cost and/or with a compact design.

Certain aspects of the present disclosure relate to systems, apparatus and methods applicable to wireless charging devices that provide a free-positioning charging surface that has multiple transmitting coils or that can concurrently charge multiple receiving devices. In one aspect, a processing circuit coupled to the free-positioning charging surface can be configured to locate a device to be charged and can select and configure one or more power transmitting coils that are optimally positioned to deliver power to the receiving device. Charging cells may be configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

According to certain aspects disclosed herein, a charging surface in a wireless charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the charging surface. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

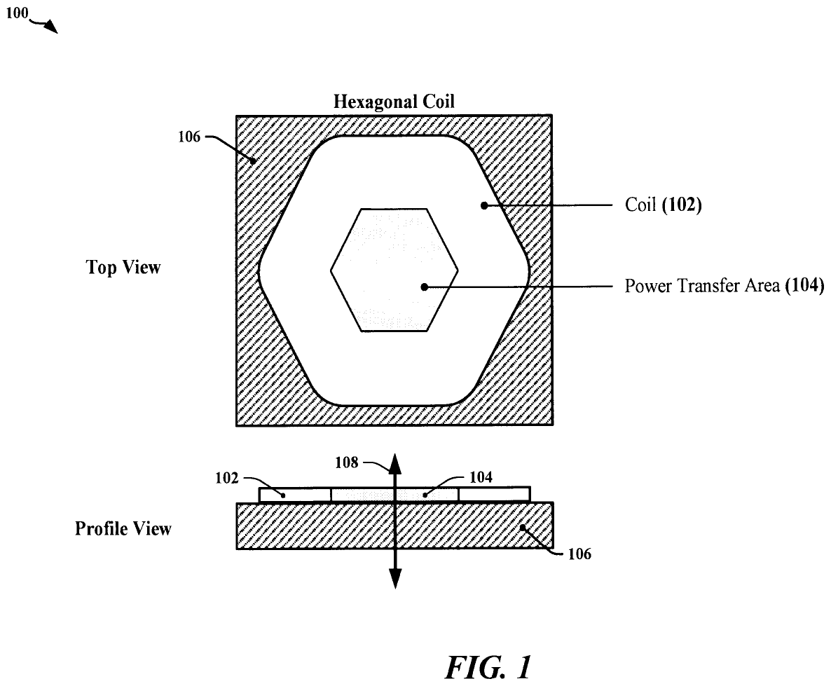

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. The wires may comprise Litz wires. Each charging cell 100 may span two or more layers separated by an insulator or substrate 106 such that coils 102 in different layers are centered around a common axis 108.

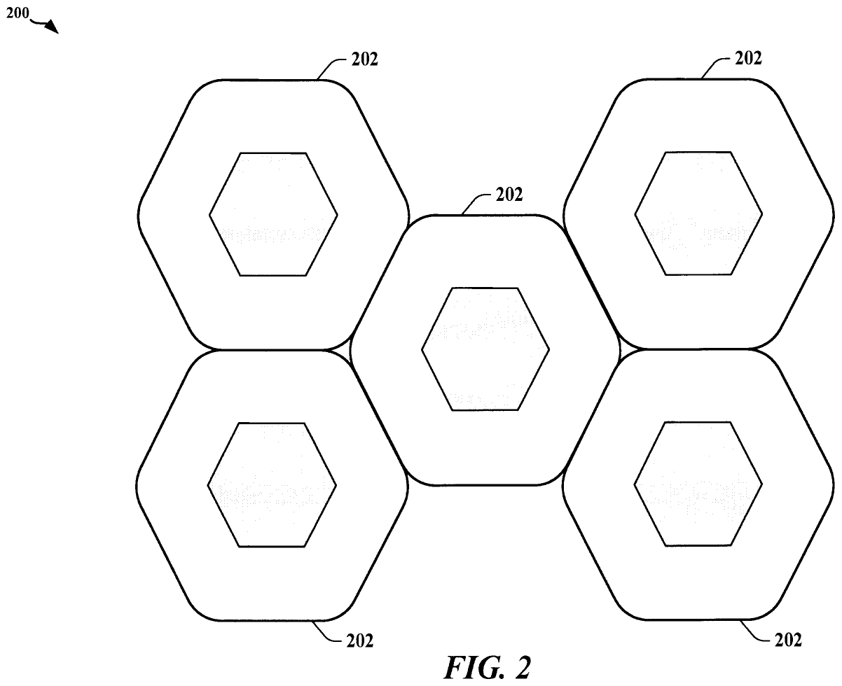

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

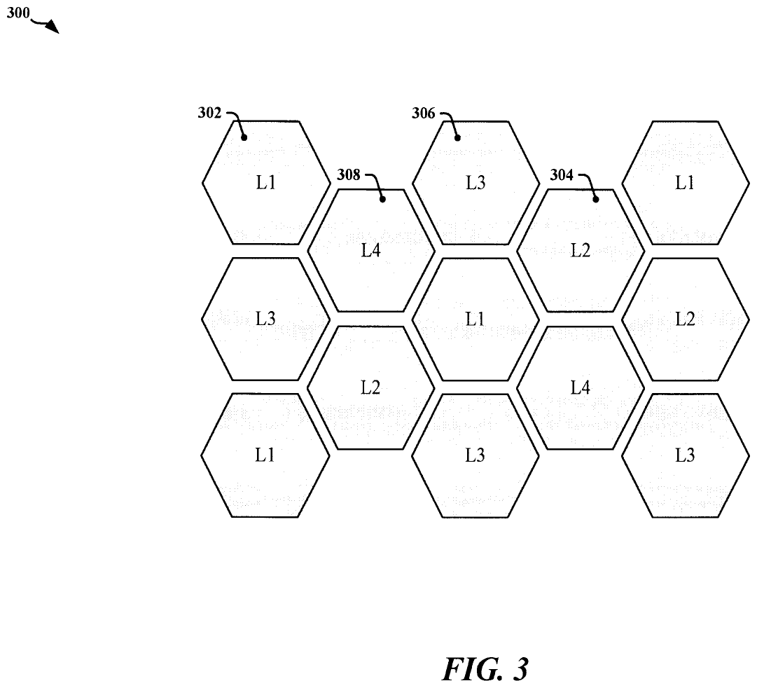

FIG. 3 illustrates the arrangement of power transfer areas provided across a charging surface 300 of a charging device that employs multiple layers of charging cells configured in accordance with certain aspects disclosed herein. The charging device may be constructed from four layers of charging cells 302, 304, 306, 308. In FIG. 3, each power transfer area provided by a charging cell in the first layer of charging cells 302 is marked “L1”, each power transfer area provided by a charging cell in the second layer of charging cells 304 is marked “L2”, each power transfer area provided by a charging cell in the third layer of charging cells 306 is marked “L3”, and each power transfer area provided by a charging cell in the fourth layer of charging cells 308 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in touch, pressure, load and/or strain. Certain aspects disclosed herein provide apparatus and methods that can sense the location of devices that may be freely placed on a charging surface using low-power differential capacitive sense techniques.

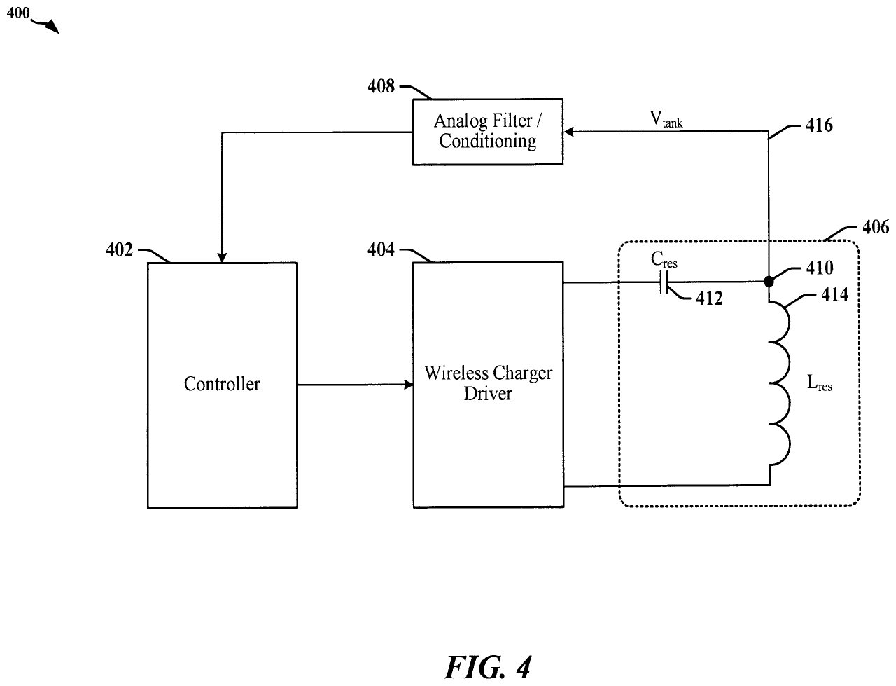

FIG. 4 illustrates an example of a wireless transmitter 400 that can be provided in a base station of a wireless charging device. A base station in a wireless charging device may include one or more processing circuits used to control operations of the wireless charging device. A controller 402 may receive a feedback signal filtered or otherwise processed by a filter circuit 408. The controller may control the operation of a driver circuit 404 that provides an alternating current to a resonant circuit 406. In some examples, the controller 402 may generate a digital frequency reference signal used to control the frequency of the alternating current output by the driver circuit 404. In some instances, the digital frequency reference signal may be generated using a programmable counter or the like. In some examples, the driver circuit 404 includes a power inverter circuit and one or more power amplifiers that cooperate to generate the alternating current from a direct current source or input. In some examples, the digital frequency reference signal may be generated by the driver circuit 404 or by another circuit. The resonant circuit 406 includes a capacitor 412 and inductor 414. The inductor 414 may represent or include one or more transmitting coils in a charging cell that produced a magnetic flux responsive to the alternating current. The resonant circuit 406 may also be referred to herein as a tank circuit, LC tank circuit, or LC tank, and the voltage 416 measured at an LC node 410 of the resonant circuit 406 may be referred to as the tank voltage.

Passive ping techniques may use the voltage and/or current measured or observed at the LC node 410 to identify the presence of a receiving coil in proximity to the charging pad of a device adapted in accordance with certain aspects disclosed herein. Some conventional wireless charging devices include circuits that measure voltage at the LC node 410 of the resonant circuit 406 or the current in the resonant circuit 406. These voltages and currents may be monitored for power regulation purposes and/or to support communication between devices. According to certain aspects of this disclosure, voltage at the LC node 410 in the wireless transmitter 400 illustrated in FIG. 4 may be monitored to support passive ping techniques that can detect presence of a chargeable device or other object based on response of the resonant circuit 406 to a short burst of energy (the ping) transmitted through the resonant circuit 406.

A passive ping discovery technique may be used to provide fast, low-power discovery. A passive ping may be produced by driving a network that includes the resonant circuit 406 with a fast pulse that includes a small amount of energy. The fast pulse excites the resonant circuit 406 and causes the network to oscillate at its natural resonant frequency until the injected energy decays and is dissipated. The response of a resonant circuit 406 to a fast pulse may be determined in part by the resonant frequency of the resonant LC circuit. A response of the resonant circuit 406 to a passive ping that has initial voltage=V₀ may be represented by the voltage V_{LC} observed at the LC node 410, such that:

$${V}_{LC} = {V}_{0} {e}^{- ( \frac{ω}{2 Q} ) t} \qquad ( Eq . 1 )$$

The resonant circuit 406 may be monitored when the controller 402 or another processor is using digital pings to detect presence of objects. A digital ping is produced by driving the resonant circuit 406 for a period of time. The resonant circuit 406 is a tuned network that includes a transmitting coil of the wireless charging device. A receiving device may modulate the voltage or current observed in the resonant circuit 406 by modifying the impedance presented by its power receiving circuit in accordance with signaling state of a modulating signal. The controller 402 or other processor then waits for a data modulated response that indicates that a receiving device is nearby. According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

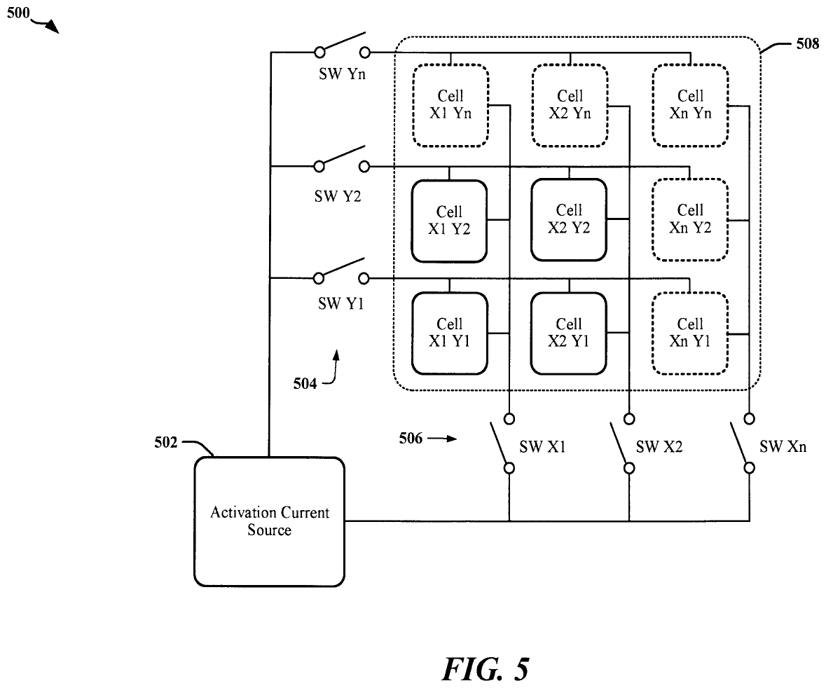

FIG. 5 illustrates a first topology 500 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIG. 2, requiring a corresponding number of switches. According to certain aspects disclosed herein, the charging cells 100 may be logically arranged in a matrix 508 having multiple cells connected to two or more switches that enable specific cells to be powered. In the illustrated topology 500, a two-dimensional matrix 508 is provided, where the dimensions may be represented by X and Y coordinates. Each of a first set of switches 506 is configured to selectively couple a first terminal of each cell in a column of cells to a first terminal of a voltage or current source 502 that provides current to activate coils in one or more charging cells during wireless charging. Each of a second set of switches 504 is configured to selectively couple a second terminal of each cell in a row of cells to a second terminal of the voltage or current source 502. A charging cell is active when both terminals of the cell are coupled to the voltage or current source 502.

The use of a matrix 508 can significantly reduce the number of switching components needed to operate a network of tuned LC circuits. For example, N individually connected cells require at least N switches, whereas a two-dimensional matrix 508 having N cells can be operated with √N switches. The use of a matrix 508 can produce significant cost savings and reduce circuit and/or layout complexity. In one example, a 9-cell implementation can be implemented in a 3×3 matrix 508 using 6 switches, saving 3 switches. In another example, a 16-cell implementation can be implemented in a 4×4 matrix 508 using 8 switches, saving 8 switches.

During operation, at least 2 switches are closed to actively couple one coil or charging cell to the voltage or current source 502. Multiple switches can be closed at once in order to facilitate connection of multiple coils or charging cells to the voltage or current source 502. Multiple switches may be closed, for example, to enable modes of operation that drive multiple transmitting coils when transferring power to a receiving device.

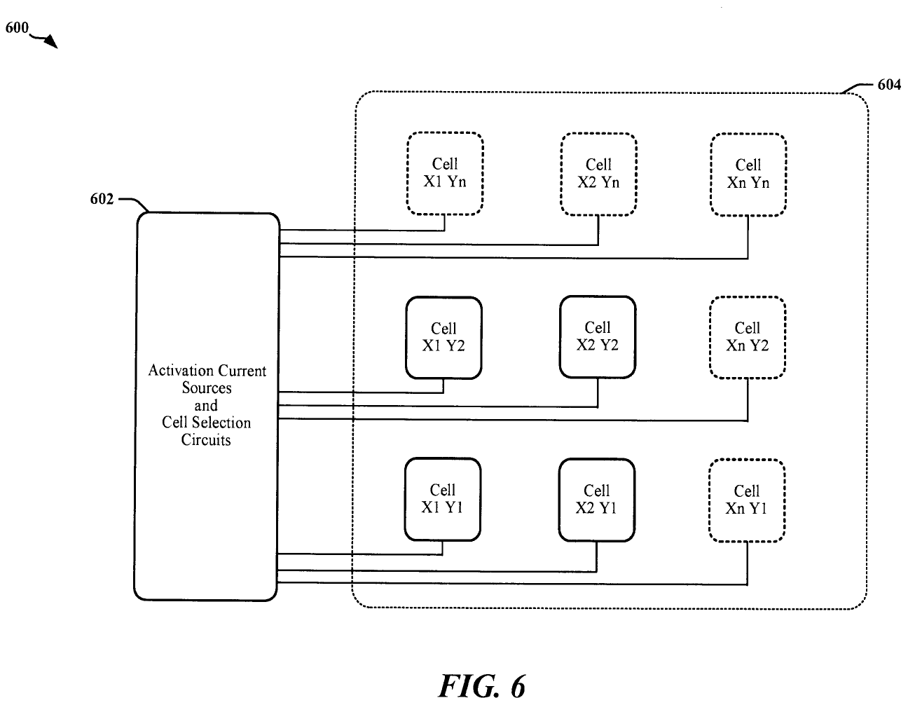

FIG. 6 illustrates a second topology 600 in which each individual coil or charging cell is directly driven by a driver circuit 602 in accordance with certain aspects disclosed herein. The driver circuit 602 may be configured to select one or more coils or charging cells 100 from a group of coils 604 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

According to certain aspects of this disclosure, a charging surface may be provided using wireless charging devices that include one or more charging coils arranged in substantially parallel alignment adjacent or proximate to the charging surface. According to one aspect, a charging system may include charging devices configured to provide a large surface area on which a chargeable device can be placed for charging and which can be controlled, managed or drive by one or more controlling subsystems. In some implementations, the charging devices may be physically coupled, joined or otherwise provided in a side-by-side or end-on-end configuration to provide a combined charging surface with a desired length, breadth or surface area. In some implementations, two or more of the charging devices may be physically separated and may provide multiple charging surfaces within a room or cabin of a vehicle or in different locations of an item of furniture, such as a desk, table, workbench, countertop including bar and kitchen worksurfaces, or the like. The charging system may include charging devices that have the same charging coil configuration, including same size and layout of charging coils. In some examples, the charging system includes different types of charging devices, including charging devices with different layouts, differently sized charging coils and/or different size. In some examples, a charging device may include charging coils of different sizes. In some examples, a charging device may include charging coils of different shapes. In some examples, a charging device may be constructed using a flexible printed circuit board (PCB) while other modular charging devices may be manufactured using inflexible materials.

According to certain aspects of this disclosure, a charging device provided in wireless charging system may be implemented using charging cells that include at least one Litz coil. A Litz coil may be constructed using a Litz wire to form a planar or substantially flat winding. The Litz coil may be configured with a central power transfer area that produces an electromagnetic flux when a charging current is passed through the Litz wire. Each charging cell may include or be associated with multiple Litz coils arranged to have coaxial or overlapping power transfer areas. In some instances, the charging cells may be arranged parallel to and adjacent to the charging surface of the charging device without overlap of the charging cells. In some instances, the charging cells may be arranged in multiple parallel layers, extending from a first layer that is parallel to, and adjacent to the charging surface of the charging device. In some instances, Litz coils in each layer may at least partially overlap Litz coils in other layers.

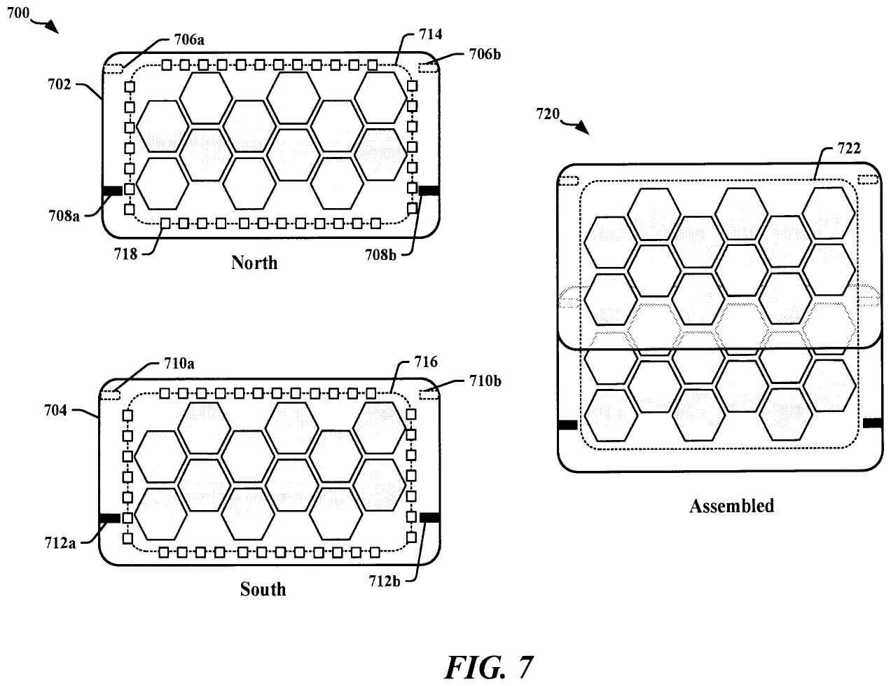

FIG. 7 illustrates an example in which a modular charging surface can be formed in accordance with certain aspects disclosed herein. The modular charging surface is constructed from two interconnected charging devices 702, 704. As illustrated in the pre-assembly view 700, the charging devices 702, 704 have a common size and shape, and a group of transmitting coils disposed across a charging surface provided by each charging device 702, 704. In this example, the charging devices 702, 704 are configured to be overlaid in either direction. In the illustrated example, the charging devices 702, 704 are configured to be overlaid in a North-South direction. Other configurations of the charging devices 702, 704 are contemplated. The charging devices 702, 704 may be overlaid to create a charging surface that is an integer N times the width of the area of a charging device 702, 704 that is delimited by an indicator line 714, 716. The illustrated assembled view 720 provides an example in which N=2, and where a North-side charging device 702 overlays a South-side charging device 704.

In certain implementations, light sources such as LED lamps or strips of LED lamps are provided to illuminate the indicator lines 714, 716 through a countertop, tabletop or other worktop. In certain implementations, the light sources may be electrically coupled to the charging device 702, as illustrated in the example by the LED lamp 718. In certain implementations, the light sources may be electrically coupled to the charging device 702, while being physically movable and/or manipulable without affecting the position of the charging device 702.

In some implementations, the indicator lines 714, 716 are defined by packaging specifications or designs and may not be physically inscribed, printed or otherwise marked on the surface of a countertop, tabletop or other worktop. In these implementations, the indicator lines 714, 716 are visible only when illuminating light is provided by at least one light source. In some implementations, the indicator lines 714, 716 may be physically marked on the countertop, tabletop or other worktop using silkscreen printing or other appropriate means, such that the indicator lines 714, 716 are visible even when the light sources are disabled. In one example, the light sources or associated light conducting materials may be visible even when no light is produced by the light sources. The indicator line 714, 716 may circumscribe the outline or outer limits of the transmitting coils.

In some implementations, light from the light sources may pass through the body of the countertop, tabletop or other worktop to illuminate the indicator lines 714, 716. In some implementations, the thickness of the countertop, tabletop or other worktop may be reduced proximate to the indicator lines 714, 716 in order to permit light from the light sources to propagate through the body of the countertop, tabletop or other worktop to illuminate the indicator lines 714, 716.

In some examples, light from the LED lamps is carried to an upper surface of the table, desk, workbench, bar top, kitchen worksurface, or other surface through light pipes, light guides and/or light diffusing materials or devices. A light pipe, for example, may be implemented LED light pipe using one or more optical fibers, a rod or shaft formed from a transparent polymer and the light pipe may be used to conduct light from an LED mounted on the charging device 702 to the upper surface of a countertop, desktop table, etc. In some implementations, light pipes, light guides or light diffusers may be used alone or in combination to provide a visible indicator line on the table, desk, workbench, bar top, kitchen worksurface, or other surface. In these latter implementations, the visible indicator line may be illuminated when a chargeable device is detected nearby. In some implementations, the charging device 702 or a controller may be configured with information that determines when the indicator line is illuminated. For example, the information may cause the indicator line to be illuminated permanently, for a defined duration, or for a period of time after occurrence of an event such as the detection of a chargeable device, presence of a user, or receipt of a command or other communication from a home automation system. The information may cause the visible indicator line to be illuminated with a first color to indicate availability of charging circuits and with a second color to indicate that the charging surface is in use. In some instances, the color of the visible indicator line may indicate whether charging is in progress or completed, or whether an error has occurred. The error may relate to misalignment of the chargeable device, presence of a foreign object, an overheating condition or the like.

Light sources, including LED lamps, may be configured to emit light that is visible to a user before placement of a device on a charging surface, after placement of the device on the charging surface and/or while charging the device through the charging surface. In some instances, the light sources may be activated when presence of a person is detected in the vicinity of the table, desk, workbench, bar top, kitchen worksurface, or other surface that includes the charging surface. For example, a change in lighting, a communication from a home automation device or controller, detection of sound or receipt of a voice command may cause the light sources to be activated. In some implementations, the frequency or rate at which the wireless charging device searches for chargeable devices may be increased when the light sources are activated. In some implementations, the frequency at which the wireless charging device searches for chargeable devices may be increased when a person is detected in the vicinity of the table, desk, workbench, bar top, kitchen worksurface, or other surface that includes the charging surface.

In various examples and configurations described in this disclosure, a charging surface may be provided as a portion of the surface of a desk, table, workbench, countertop including bar and kitchen worksurfaces, or other item of furniture through which electromagnetic flux can be delivered by one or more power transmitting coils in a wireless charging device. Typically, the wireless charging device is located below the surface of the desk, table, workbench, countertop, bar worksurface, kitchen worksurface, or an item of furniture.

The transmitting coils of the charging devices 702, 704 may be arranged in a pattern that continues uninterrupted when the charging devices 702, 704 are overlaid. A combined indicator line 722 may be defined by the location of LED lamps, portions of strips of LED lamps or other light sources that are available for use during operation of the charging device. A processing circuit may manage operation of the LEDs or strips of LEDs. In one example, a controller of the processing circuit may detect the presence or absence of a chargeable device and may select some combination of LED lamps to be illuminated in order to provide a visual reference that assists a user to properly locate the charging surface. The controller may also configure colors for the LEDs to indicate state and progress of a charging transaction, error conditions and the like. In one example, the controller may configure a first color for the LEDs to indicate a charging area that is available for charging, a second color for the LEDs to indicate the charging area is being used for charging, and a third color for the LEDs to indicate that charging has been completed. In one example, the controller may configure a first sequence of color changes for the LEDs to indicate a charging area that is available for charging, a second sequence of color changes for the LEDs to indicate the charging area is being used for charging, and a third sequence of color changes for the LEDs to indicate that charging has been completed. Each sequence of color changes may the LEDs to emit a pattern of light. The controller may configure the intensity of light emitted by the LEDs to accommodate changes in ambient lighting.

In the illustrated example, each charging device 702, 704 has underside connector areas 706a, 706b, 710a, 710b and topside connector areas 708a, 708b, 712a, 712b that are positioned to overlap when the charging devices 702, 704 are overlaid. Mechanical fasteners may be located in the underside connector areas 706a, 706b, 710a, 710b and topside connector areas 708a, 708b, 712a, 712b. Mechanical fasteners may include bonding points, screws, or other devices that can fasten and/or hold the charging devices 702, 704 in place when overlaid. Electrical connectors may be located in the underside connector areas 706a, 706b, 710a, 710b and topside connector areas 708a, 708b, 712a, 712b. The electrical connectors may conduct data communication links and/or charging currents between the charging devices 702, 704 enabling a controller to configure and operate groups of transmitting coils when charging a receiving device placed on or near the charging surface.

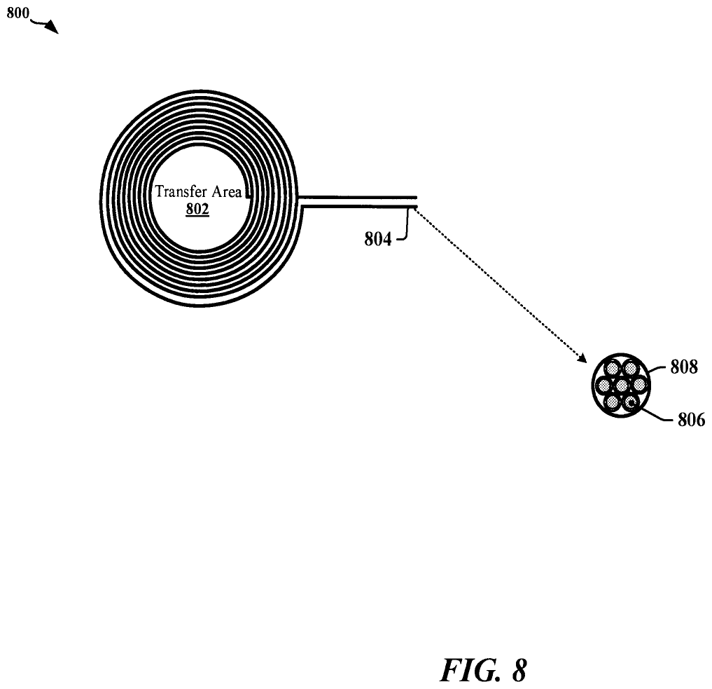

FIG. 8 illustrates an example of a transmitting coil configured in accordance with certain aspects of this disclosure. The transmitting coil may be wound from a multi-stranded Litz wire 804 and may be referred to as a Litz coil 800. Each strand 806 of the Litz wire 804 is formed as an insulated conductor that is sufficiently thin to mitigate or substantially reduce skin effect loss. Skin effect losses occur in wires carrying high frequency signals where the current tends to flow at outermost reaches (skin) of the wire. The strands 806 are insulated to maintain their individual nature and are twisted such that the relative positioning of the individual strands 806 changes over the length of the Litz wire 804. In some instances, the strands 806 are bound by an exterior insulating layer 808. The Litz coil 800 is wound as a substantially planar coil with an open interior that corresponds to the power transfer area 802.

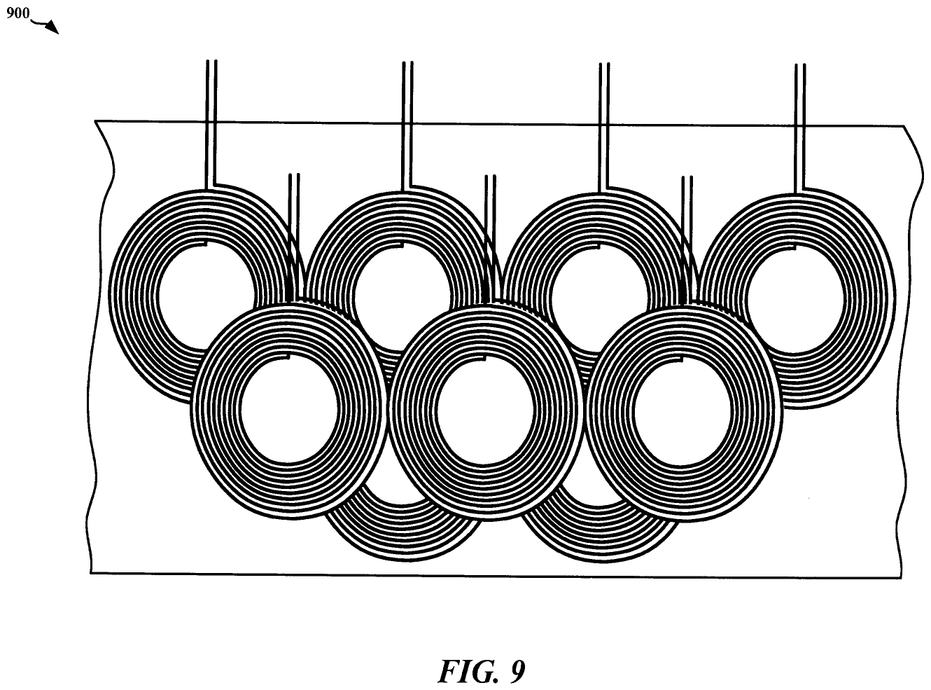

FIG. 9 illustrates an example of a portion of a charging surface 900 provided using multiple overlapping Litz coils 800. In the illustrated example, the charging surface 900 is constructed using three layers of Litz coils 800, although the number of layers of Litz coils 800 and arrangement of the Litz coils 800 in the charging surface 900 may vary according to application, size of the charging surface 900 and power transfer requirements per Litz coil 800.

The configuration of Litz coils 800 in a charging surface 900 may be precisely defined by design requirements. In some instances, it can be difficult to manage and align the number of Litz coils 800 to be assembled during manufacture of a wireless charging device that provides a free-positioning charging surface using multiple transmitting coils. Variability in positioning of the Litz coils 800 during manufacture can result in imprecise configurations of coils in some finished devices. In some instances, the Litz coils 800 may be retained in position using an adhesive or epoxy resin. According to certain aspects of this disclosure, a substrate may be configured to receive the Litz coils 800 and maintain the Litz coils 800 in a desired configuration for the lifetime of the wireless charging device.

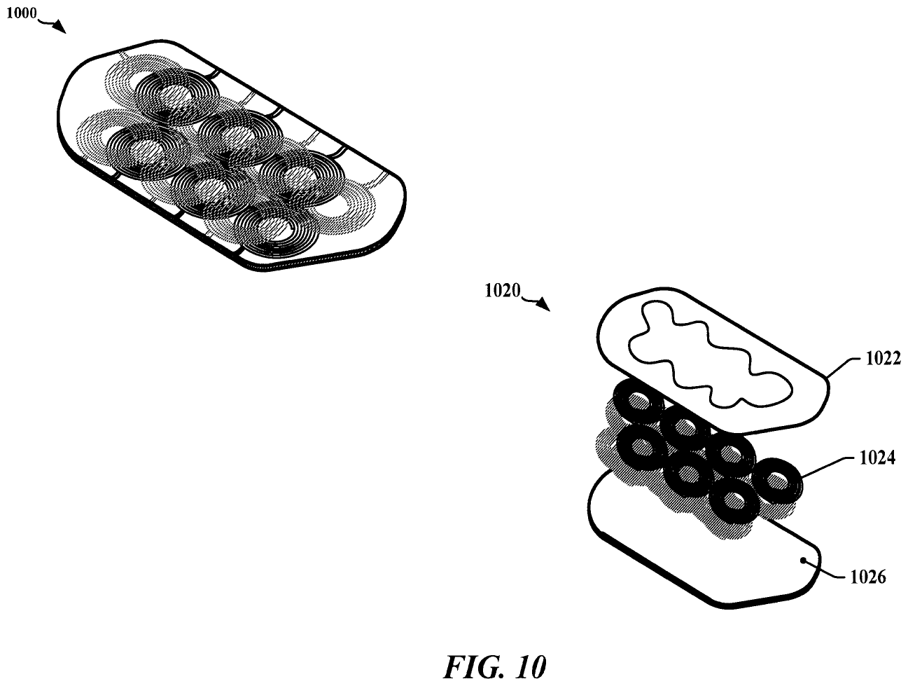

FIG. 10 illustrates a charging assembly 1000 in a wireless charging device constructed from Litz coils 800 according to certain aspects of this disclosure. The exploded view 1020 shows a Litz coil substrate 1022 configured to receive Litz coils and maintain the Litz coils in a predefined multi-layer Litz coil structure 1024 with 3D displacements between coils that meet tolerances defined by a designer. The Litz coil substrate 1022 may also define the spatial relationship between the multi-layer Litz coil structure 1024 and a ferrite layer 1026 or another type of magnetic half-core.

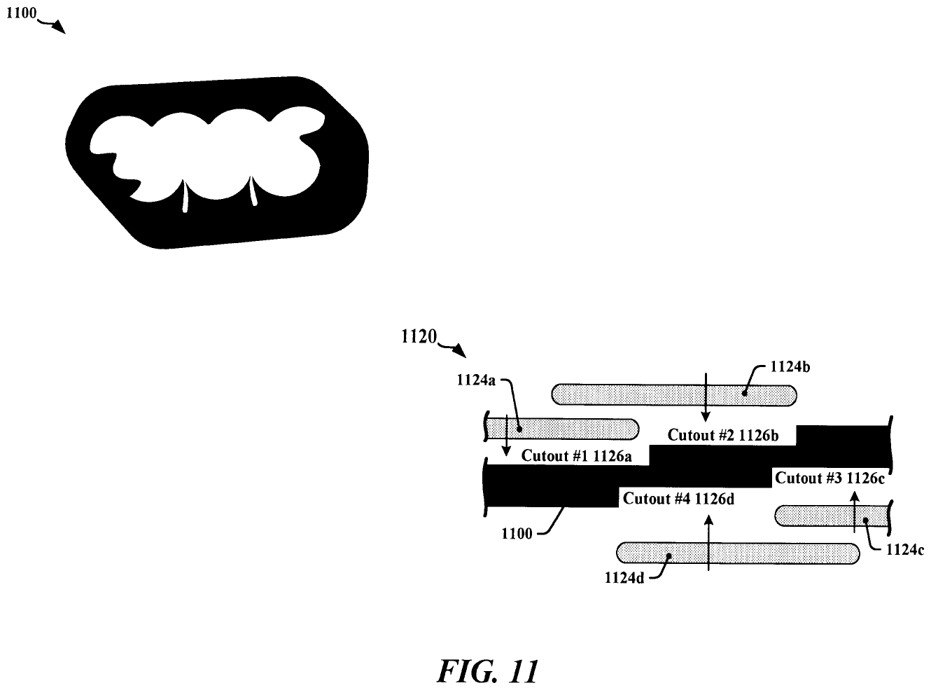

FIG. 11 illustrates certain aspects of a Litz coil substrate 1100 provided in accordance with certain aspects of this disclosure. The Litz coil substrate 1100 may be formed from a polymer, acetate, vinyl, nitrile rubber, latex, extruded polystyrene foam and/or other material. The Litz coil substrate 1100 may have multiple cutouts that enable Litz coils 800 to be placed in position in an ordered assembly. In some examples, the cut-outs may be preformed, including when the Litz coil substrate 1100 is manufactured by 3D printing, molding, extrusion and/or low-pressure expansion. In some examples, the cut-outs may be formed by milling, grinding, etching, abrading, chemical erosion, chemical dissolution or by another technique suitable for use with the material used to form the Litz coil substrate 1100.

Certain aspects of the Litz coil substrate 1100 are illustrated in a cross-sectional view 1120. The illustrated Litz coil substrate 1100 provides a four-layer charging surface and the cross-sectional view 1120 illustrates an example of placement and assembly of four Litz coils 1124a-1124d. The Litz coil substrate 1100 has a deep, first cutout 1126a in the Litz coil substrate 1100 that receives a first Litz coil 1124a. This first cutout 1126a may be formed as a complete circle in some examples. In other examples, the first cutout 1126a may have a portion that overlaps a portion of another cutout in the same plane of the Litz coil substrate 1100.

When the first Litz coil 1124a has been secured within the first cutout 1126a, a second Litz coil 1124b may be placed in a second cutout 1126b in the Litz coil substrate 1100. When in position within the Litz coil substrate 1100, the second Litz coil 1124b lies in a plane above the plane that includes the first Litz coil 1124a. A portion of the second Litz coil 1124b overlaps a portion of the first Litz coil 1124a. The separation of the planes that include the horizontal center lines of the first Litz coil 1124a and the second Litz coil 1124b may be configured by the relative difference in depths of the first cutout 1126a and the second cutout 1126b.

The third Litz coil 1124c is received by a deep, third cutout 1126c in the Litz coil substrate 1100. This third cutout 1126c may be formed as a complete circle in some examples. In other examples, the third cutout 1126c may overlap with another cutout in the same plane. In one example, the third cutout 1126c may partially overlap the first cutout 1126a resulting in a through-hole, when the bottom surface of the first Litz coil 1124a is in the same plane as the top surface or some other portion of the third Litz coil 1124c.

When the third Litz coil 1124c has been secured within the third cutout 1126c, a fourth Litz coil 1124d may be placed in a fourth cutout 1126d. The fourth Litz coil 1124d lies in a plane below the plane that includes the third Litz coil 1124c. A portion of the fourth Litz coil 1124d overlaps a portion of the third Litz coil 1124c when secured within the Litz coil substrate 1100. The separation of the planes that include the horizontal center lines of the third Litz coil 1124c and the fourth Litz coil 1124d may be configured by the relative difference in depths of the third cutout 1126c and the fourth cutout 1126d.

A Litz coil 1124a-1124d may be secured within the Litz coil substrate 1100 through a pressure fit, including when the Litz coil substrate 1100 is manufactured from a foam material. In some examples, a Litz coil 1124a-1124d may be secured within the Litz coil substrate 1100 by adhesive. In some examples, a Litz coil 1124a-1124d may be secured within the Litz coil substrate 1100 by mechanical means.

In some implementations, a completed charging assembly comprising the Litz coil substrate 1100 and the Litz coils 1124a-1124d may be attached to, or mounted on a substrate, which may be retained within a housing that can be mounted under a countertop, for example. In some implementations, the completed charging assembly comprising the Litz coil substrate 1100 and the Litz coils 1124a-1124d may be attached to, or mounted on a printed circuit board, which may be retained within a housing.

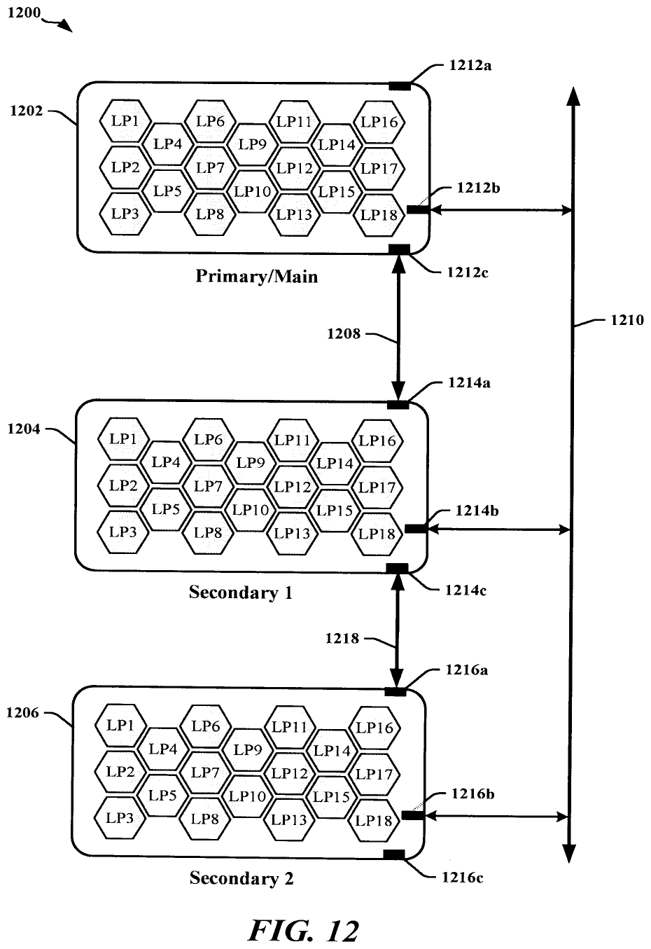

FIG. 12 illustrates an example of a charging system 1200 that includes multiple charging devices 1202, 1204, 1206 provided in accordance with certain aspects of this disclosure. In one example, the charging devices 1202, 1204, 1206 may be physically joined or interconnected to provide a single scalable, modular charging surface. In some examples, one or more of the charging devices 1202, 1204, 1206 may be remotely located from at least one other charging device 1202, 1204, 1206 to provide distributed charging surfaces. The charging system 1200 may include one or more controllers that can communicate with the charging devices 1202, 1204, 1206. In one example, a primary controller may communicate control messages to a secondary controller over a data communication link. In some examples, a primary controller may provide control signals that are used to control charging or detection operations at the charging devices 1202, 1204, 1206. In some examples, the primary controller may control power flow in the charging devices 1202, 1204, 1206. In some examples, the primary controller may provide charging currents to one or more groups of charging coils on the charging devices 1202, 1204, 1206.

Each charging device 1202, 1204, 1206 may include one or more charging cells that encompass one or more power transfer areas. Each power transfer area is substantially planar and centered around an axis that is substantially perpendicular to its a charging surface of its associated charging device 1202, 1204, 1206. In some examples, each of the charging devices 1202, 1204, 1206 can operate as a standalone wireless charger that includes controllers and power management circuits. The standalone wireless charger may be configured to detect chargeable devices, generate charging configurations and provide a charging current to one or more charging cells identified by the charging configurations.

In some examples, certain charging devices 1204, 1206 operate as secondary devices that have limited capability. In one example, the limited-capability charging devices 1204, 1206 receive charging currents through dedicated connectors and the charging currents are directed to one or more charging cells through fixed electrical paths or through a switch that may be controlled by a primary charging device 1204 or other centralized or distributed controller. In another example, the limited-capability charging devices 1204, 1206 may have a controller capable of selecting charging cells to receive a charging current and to provide the charging current to the selected charging cells. In the latter example, some limited-capability charging devices 1204, 1206 may be configured to exchange messages with one or more other charging devices 1202, 1204, 1206 in the system, or exchange messages with a chargeable device. In some instances, the limited-capability charging devices 1204, 1206 may be capable of conducting searches for chargeable devices or may be configured to participate in a search for chargeable devices controlled by a primary charging device 1204 or other centralized or distributed controller.

The charging system 1200 is constructed from interconnected charging devices 1202, 1204, 1206. The charging devices 1202, 1204, 1206 may have a same or different size or shape. The charging devices 1202, 1204, 1206 may have a same or different number or configuration of power transmitting coils. In the illustrated example, the charging devices 1202, 1204, 1206 have similar size, shape and transmitting coil configuration, although the charging devices 1202, 1204, 1206 have a same or different configuration in other implementations.

In certain examples, each of the charging devices 1202, 1204, 1206 includes one or more connectors 1212a, 1212b, 1212c, 1214a 1214b, 1214c, 1216a 1216b, 1216c, which may couple the charging devices 1202, 1204, 1206 to a multi-drop serial bus 1210 or support a daisy chain connection 1208, 1218. In one example, the multi-drop serial bus 1210 is configured as a serial bus that enables the charging devices 1202, 1204, 1206 to exchange command and control messages. In one example, the serial bus is operated in accordance with Improved Inter-Integrated Circuit (13C) protocols, Controller Area Network (CAN) bus protocols, Local Interconnected Network (LIN) bus protocols, or the like. In some instances, the charging devices 1202, 1204, 1206 may communicate wirelessly. In some implementations, the daisy chain connection 1208, 1218 is used to distribute charging current among the charging devices 1202, 1204, 1206. The daisy chain connection 1208, 1218 may also be used for exchanging command and control messages.

In one example, one or more of the charging devices 1202, 1204, 1206 can serve as a primary device and may include a processing circuit configured to manage operation of one or more charging devices 1202, 1204, 1206 that is operated as a secondary device. In the illustrated example, two charging devices 1204, 1206 operate as secondary devices and may include processing circuits configured to communicate over the multi-drop serial bus 1210 in order to receive commands from the primary charging device 1202 and to report feedback information to the primary charging device 1202. Secondary charging devices 1202, 1204, 1206 may include or control a driver circuit that provides a flow of a charging current provided through the daisy chain connection 1208, 1218, when the charging current is provided by a current source through the operation of the primary charging device 1202.

The secondary charging devices 1204, 1206 may cooperate with the primary charging device 1202 to discover, enumerate and configure the combination of charging devices 1202, 1204, 1206 provided in the charging system 1200. In one example, the secondary charging devices 1204, 1206 participate in a serial bus arbitration process to identify themselves to the primary charging device 1202 and/or to obtain unique addresses. In another example, the secondary charging devices 1204, 1206 may be preconfigured with at least a secondary address that the primary charging device 1202 can use to address each secondary charging device 1204, 1206 through the multi-drop serial bus 1210. The primary charging device 1202 may use the multi-drop serial bus 1210 to configure the secondary charging devices 1204, 1206, interrogate the secondary charging devices 1204, 1206 for capability, charging cell size, number and configuration as well as status information. The primary charging device 1202 may use the multi-drop serial bus 1210 to configure the secondary charging devices 1204, 1206 for one or more charging operations.

In some implementations, each of the charging devices 1202, 1204, 1206 can be independently connected to a power supply that can be used to provide and configure a charging current. In one example, the charging devices 1202, 1204, 1206 may include an inverter or switching power supply configurable to produce an alternating current (AC) that has frequency suitable for wireless charging. In some implementations, each of the charging devices 1202, 1204, 1206 may be coupled to a multi-purpose communication bus that is used by other devices or systems (in an automobile for example). In the latter implementations, the primary charging device 1202 may also be a controlling entity on the bus.

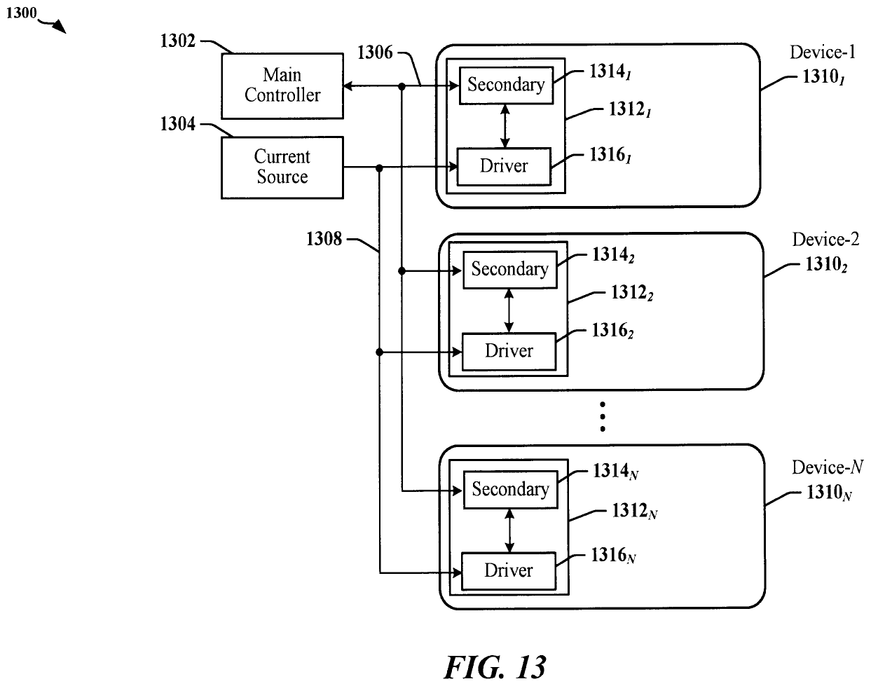

FIG. 13 illustrates a first example of a combined control circuit 1300 in a charging system provided in accordance with certain aspects disclosed herein. Each charging device 1310₁-1312_{N} includes a processing circuit 1312₁-1312_{N} that is configured and controlled by a main controller 1302 to manage operation of its respective charging device 1310₁-1312_{N}. In one example, each processing circuit 1312₁-1312_{N} includes a secondary circuit 1314₁-1314_{N} configured to communicate over a serial bus 1306 in order to receive commands and report feedback information to the main controller 1302. The secondary circuit 1314₁-1314_{N} may control a driver circuit 1316₁-1316_{N} that controls flow of a charging current provided through an interlink 1308 by a current source 1304.

The secondary circuits 1314₁-1314_{N} may cooperate with the main controller 1302 to discover, enumerate and configure the combination of charging devices 1310₁-1312_{N} provided in the modular charging surface. In one example, the secondary circuits 1314₁-1314_{N} participate in an arbitration process to identify themselves to the main controller 1302 and/or to obtain unique addresses. In another example, the secondary circuits 1314₁-1314_{N} may be preconfigured with at least a secondary address that the main controller 1302 can use to address each secondary circuit 1314₁-1314_{N} through the serial bus 1306. The main controller 1302 may use the serial bus 1306 to configure the secondary circuits 1314₁-1314_{N}, interrogate the secondary circuits 1314₁-1314_{N} for capability and status information, and configure the secondary circuits 1314₁-1314_{N} for one or more charging operations.

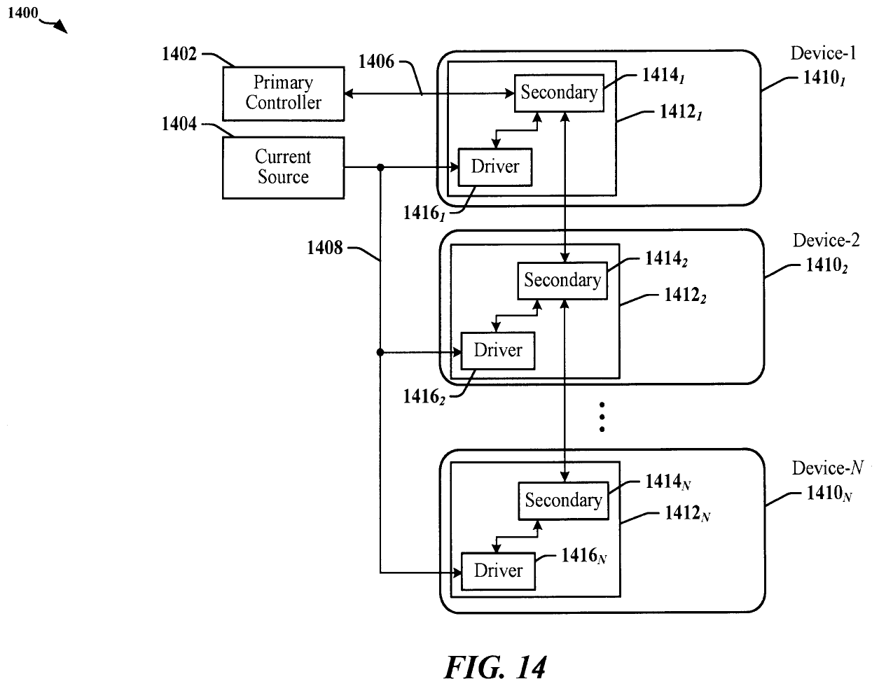

FIG. 14 illustrates a second example of a combined control circuit 1400 that may be provided in a charging system provided in accordance with certain aspects disclosed herein. Each charging device 1410₁-1412_{N} includes a processing circuit 1412₁-1412_{N} that is configured and controlled by a main controller 1402 to manage operation of its respective charging device 1410₁-1412_{N}. In one example, each processing circuit 1412₁-1412_{N} includes a secondary circuit 1414₁-1414_{N} configured to communicate over a serial bus 1406 in order to receive commands and report feedback information to the main controller 1402. The secondary circuit 1414₁-1414_{N} may control a driver circuit 1416₁-1416_{N} that controls flow of a charging current provided through an interlink 1408 by a current source.

The secondary circuits 1414₁-1414_{N} may cooperate with the main controller 1402 to discover, enumerate and configure the combination of charging devices 1410₁-1412_{N} provided in the modular charging surface. In the illustrated example, the secondary circuits 1414₁-1414_{N} are connected in a daisy chain fashion, whereby the main controller 1402 connects with and configures a first secondary circuit 1414₁, which then couples the second secondary circuit 1414₂ to the main controller 1402 through the serial bus 1406. The main controller 1402 configures the second secondary circuit 1414₂ and the process continues until the last secondary circuit 1414_{N} has been configured. In another example, the secondary circuits 1414₁-1414_{N} may be preconfigured with at least a secondary address that the main controller 1402 can use to address each secondary circuit 1414₁-1414_{N} through the serial bus 1406.

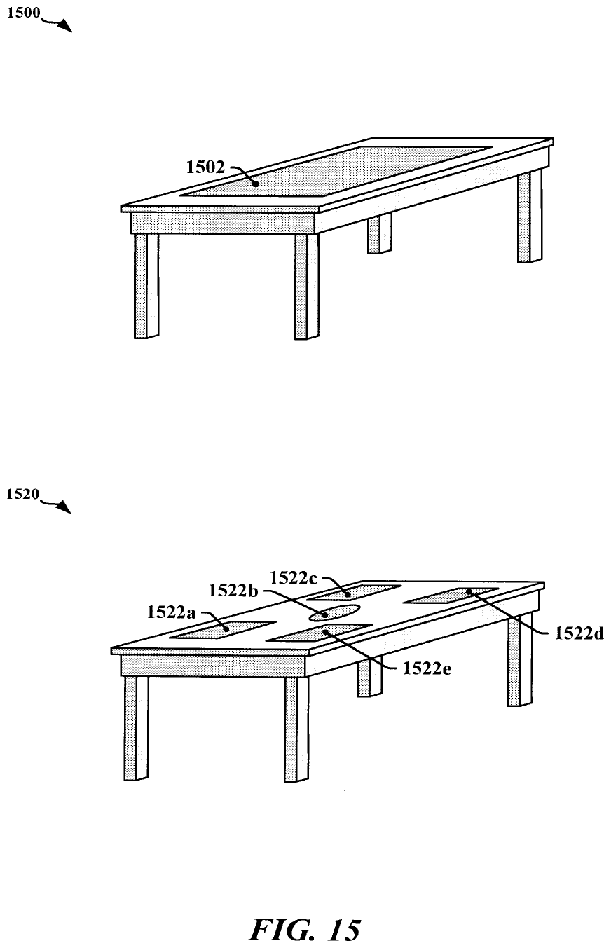

FIG. 15 illustrates the use of charging devices to provide one or more charging areas on an item of furniture in accordance with certain aspects of this disclosure. In certain implementations, the charging surface on an upper surface of a countertop, for example, may be a projection of the charging surface of a wireless charging device through the countertop. The charging surface can be expected to occupy an area that closely corresponds to the dimensions of the charging surface of the wireless charging device.

The illustrated charging devices may be provided in a desk, table 1500, 1520, workbench, countertop including bar and kitchen worksurfaces, or the like. The charging devices may be provided in other items including armrests of an armchair, armrests in an automobile, windowsills in a room, consoles in a vehicle, tray tables in an airplane and other examples. The example of a table 1500, 1520 is used in FIG. 15 for clarity and to facilitate description of certain aspects of a wireless charging system. A first table 1500 is equipped with a large charging surface 1502 that may be assembled from numerous charging modules that are arranged and configured to provide the large charging surface 1502. A second table 1520 is equipped with multiple charging surfaces 1522a-1522e that can have different sizes or shapes. Each of the charging surfaces 1522a-1522e may be implemented using one or more charging modules constructed in accordance with the examples illustrated in FIGS. 7-14. In some examples, at least one of the charging modules may differ from other charging modules in overall size or shape or by the number, size or configuration of included charging coils.

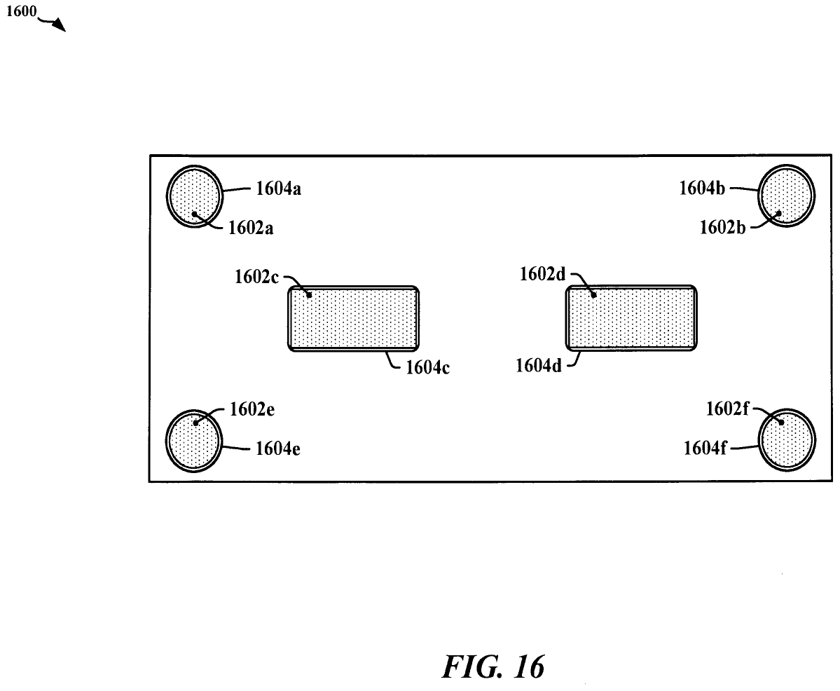

FIG. 16 illustrates an example of a modular charging device layout on a surface 1600 of a table, desk, workbench, countertop, bar top, kitchen worksurface, or other item of furniture in accordance with certain aspects of this disclosure. Modular charging devices may be provided in other items including armrests of an armchair, armrests in an automobile, windowsills in a room, consoles in a vehicle, tray tables in an airplane and other examples. The modular charging devices are deployed to provide multiple charging areas 1602a-160f across the surface 1600 of the table, desk, workbench, countertop, bar top, kitchen worksurface, or other item of furniture. In some examples, at least one of the charging modules may differ from other charging modules in overall size or shape or by the number, size or configuration of included charging coils.

In the illustrated example, each of the charging areas 1602a-1602f is circumscribed by an indicator line 1604a-1604f that follows the shape of the corresponding charging area 1602a-1602f. In some implementations, the indicator lines 1604a-1604f may be formed on the surface of the table, desk, workbench, bar top, kitchen worksurface, or other item of furniture. The term “indicator line” as used herein applies to a straight or curved line that follows at least a portion of the perimeter of a charging area 1602a-1602f. In one example, one or more indicator lines may be provided to encircle, encompass or circumscribe a charging area 1602a-1602f. In some instances, an indicator line may fully enclose a shape such as a circle, oval square rectangle or other regular or irregular shape. In some instances, an indicator line may be partially illuminated such that some points, dots or sections of the indicator line are illuminated and other points, dots or sections of the indicator line are not illuminated. Indicator lines are depicted in the drawings using a solid, dotted or dashed line regardless of whether the corresponding indicator line can be illuminated along the entirety of its length or illuminated at certain points, dots or sections of the indicator line.

In certain implementations, the indicator lines 1604a-1604f may be obtained by projecting light onto a lower surface of the table, desk, workbench, bar top, kitchen worksurface, or other item of furniture such that some portion of the light penetrates the surface. In some implementations, a countertop may be fabricated from stone, ceramic or other material that is translucent or capable of conducting light. The light may produce illuminated shapes such as lines, dots, or some combination of lines and dots on the countertop to indicate one or more active charging areas. In one example light generated by LED lamps or strips may penetrate 2 centimeters (2 cm) or more through a stone countertop. In other examples, the density of the stone may significantly limit the light conducted from a lower surface to the upper surface such that the thickness of the countertop proximate to the indicator lines 1604a-1604f is less than 2 cm.

It is contemplated that, in some instances, a transparent, semitransparent, translucent or diaphanous material may be inlaid or embedded in an otherwise opaque countertop material to form the indicator lines 1604a-1604f. In some instances, an inlay provided in the otherwise opaque countertop may have light refracting and/or light diffusing properties such that the indicator lines 1604a-1604f may be formed by conducting light through the inlay. In some instances, the inlay may comprise a broken line of holes or channels that are filled with an inlaid or embedded material.

In some implementations, light sources such as LED lamps or strips of LED lamps can be used to illuminate the indicator lines 1604a-1604f. The LED lamps may be configured to emit colored light that is visible to a user during placement and/or charging of a device through the charging surface. In some examples, light from the LED lamps is carried through light pipes, light guides and/or light diffusers to an upper surface of the table, desk, workbench, bar top, kitchen worksurface, or other item of furniture. In some implementations, the light pipes, light guides or light diffusers may be used alone or in combination to provide the visible indicator line 1604a-1604f on the table, desk, workbench, bar top, kitchen worksurface, or other item of furniture. In these latter implementations, the visible indicator line 1604a-1604f may be illuminated when a chargeable device is detected nearby, or may be in an always on state. The visible indicator line 1604a-1604f may present a first color to indicate availability of charging circuits and may present a second color to indicate that the charging surface is in use. In some instances, the color of the visible indicator line 1604a-1604f may indicate whether charging is in progress or completed, or whether an error has occurred. The error may relate to misalignment of the chargeable device, presence of a foreign object, an overheating condition or the like.

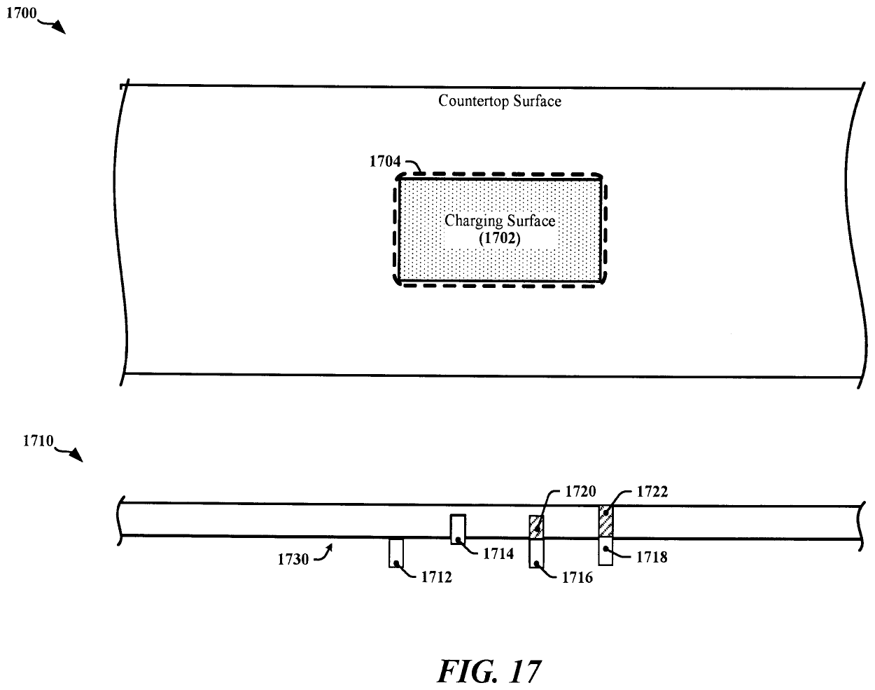

FIG. 17 illustrates certain examples in which light sources 1712, 1714, 1716, 1718 may be positioned below the surface of a countertop 1700 that includes a charging surface 1702 configured in accordance with certain aspects of this disclosure. The countertop 1700 may be provided on a table, desk, workbench, bar top, kitchen worksurface or other item of furniture. In some implementations, one or more of the light sources 1712, 1714, 1716, 1718 comprises an LED lamp. In some implementations, one or more of the light sources 1712, 1714, 1716, 1718 comprises a string of LEDs lamp, although only one representative LED lamp is illustrated in the cross-sectional view 1710 of the countertop 1700. In some implementations, one or more of the light sources 1712, 1714, 1716, 1718 comprises an LED strip configured to follow the boundary of a charging device that defines the charging surface 1702, with a cross-section of the LED strip being illustrated in the cross-sectional view 1710 of the countertop 1700.

The illustrated examples depict four examples in which an indicator line 1704 can be illuminated around the charging surface 1702 using light provided by the light sources 1712, 1714, 1716, 1718. Each of the light sources 1712, 1714, 1716, 1718 is located on the underside of the countertop 1700. In a first example, the light source 1712 may be positioned directly below the countertop 1700. The light source 1712 may contact the lower surface 1730 of the countertop 1700, or may be positioned some distance from the lower surface 1730 of the countertop 1700. In some instances, the light source 1712 is placed a sufficient distance from the lower surface 1730 of the countertop 1700 to permit an LED laser or other light source to draw (illuminate) a line on the lower surface 1730 of the countertop 1700. In some implementations, the light source 1712 is deployed or attached to a charging device 702, 704 (see FIG. 7) that is configured to transmit electromagnetic flux through the countertop 1700 and across the charging surface 1702.

In a second example, a light source 1714 may be installed within the countertop 1700. In this example, a hole or channel penetrates the lower surface 1730 of the countertop 1700 but does not reach the upper surface of the countertop 1700. The hole or channel may be dimensioned to embed the light source 1714 at least partially in the countertop 1700 through the lower surface 1730. The light source 1714 may comprise an LED strip or one or more LED lamps. The hole or channel operates to reduce the thickness of countertop material in the optical path between the upper surface of the countertop 1700 and the light source 1714. The amount of the reduction in thickness of the countertop 1700 may be based on the type of material used to construct the countertop 1700. In some examples, the thickness of an area of the countertop 1700 along an LED strip or next to an LED lamp may be reduced to between 1 and 3 centimeters. In some examples, the thickness of an area of the countertop 1700 along an LED strip or next to an LED lamp may be reduced to between 1 and 10 millimeters. In some implementations, a small area surrounding each of multiple points on the surface of the countertop may have a reduced thickness. In some instances, a series of holes provided in the lower surface 1730 of the countertop 1700 are dimensioned to receive and/or retain the LED lamps included in the light source 1714. In some implementations, the light source 1714 is deployed or attached to a charging device 702, 704 (see FIG. 7) that defines the charging surface 1702.

In a third example, a light source 1716 may be positioned directly below the countertop 1700. A light emitting surface of the light source 1716 may abut the lower surface 1730 of the countertop 1700, or may be positioned some distance from the lower surface 1730 of the countertop 1700. In some instances, the light source 1716 is placed a sufficient distance from the lower surface 1730 of the countertop 1700 to permit an LED laser or other lamp to draw (illuminate) a line on the lower surface 1730 of the countertop 1700. In some implementations, the light source 1716 is deployed or attached to a charging device 702, 704 (see FIG. 7) that defines the charging surface 1702. In this example, a hole or channel 1720 penetrates the lower surface 1730 of the countertop 1700 but does not reach the upper surface of the countertop 1700. A transparent, semitransparent, translucent or diaphanous material may be inserted, infused, inlaid or otherwise embedded in the hole or channel 1720 to conduct light from the light source 1716 through the countertop 1700 to a position near the upper surface of the countertop 1700. In some instances, the hole or channel may be dimensioned to receive or maintain one or more light pipes, light guides or light diffusers. In some instances, the light pipes, light guides or light diffusers may be provided instead of, or in addition to the transparent, semitransparent, translucent or diaphanous material. The light source 1716 may comprise an LED strip or one or more LED lamps. In some instances, a channel or a series of holes provided through the countertop 1700 can be dimensioned to receive and/or retain the LED lamps, light pipes, light guides or light diffusers coupled to the light source 1716. In some implementations, the light source 1716 is deployed or attached to a charging device 702, 704 (see FIG. 7) that defines the charging surface 1702.

In a fourth example, a light source 1718 may be installed within or below the countertop 1700. In this example, a through-hole 1722 is provided in the countertop 1700. In some instances, the light source 1718 may be embedded at least partially in the countertop 1700 through the lower surface 1730. In some instances, a light emitting surface of the light source 1718 may abut the lower surface 1730 of the countertop 1700, or may be positioned some distance from the lower surface 1730 of the countertop 1700. In some instances, the light source 1718 is placed a sufficient distance from the lower surface 1730 of the countertop 1700 to permit an LED laser or other lamp to illuminate the base of the through-hole 1722. In some implementations, the light source 1718 is deployed or attached to a charging device 702, 704 (see FIG. 7) that defines the charging surface 1702. In this example, the through-hole 1722 penetrates the lower surface 1730 of the countertop 1700 and reaches the upper surface of the countertop 1700.

A transparent, semitransparent, translucent or diaphanous material may be inserted, inlaid or embedded in the through-hole 1722. In some instances, the through-hole 1722 may be dimensioned to receive or maintain light pipes, light guides or light diffusers. In some instances, the light pipes, light guides or light diffusers may be provided below one or more layers of transparent, semitransparent, translucent or diaphanous material. The light source 1718 may comprise an LED strip or one or more LED lamps. In some instances, the through-hole 1722 may be one of a series of holes provided through the countertop 1700 to provide the indicator line 1704. In some implementations, the light source 1718 is deployed or attached to a charging device 702, 704 (see FIG. 7) that defines the charging surface 1702.

A method for wireless charging according to certain aspects of this disclosure includes illuminating one or more indicator lines to identify a physical location of a charging area available to wirelessly charge a chargeable device, and providing a charging current to one or more power transmitting coils after determining that a chargeable device has been placed within the charging area. In one example, the method includes configuring a first color for the indicator lines to indicate a charging area that is available for charging the chargeable device, configuring a second color for the indicator lines to indicate the charging area is being used for charging the chargeable device, and configuring a third color for the indicator lines to indicate that charging the chargeable device has been completed. In another example, the method includes configuring a first sequence of color changes for the indicator lines to indicate a charging area that is available for charging the chargeable device, configuring a second sequence of color changes for the indicator lines to indicate the charging area is being used for charging the chargeable device, and configuring a third sequence of color changes for the indicator lines to indicate that charging the chargeable device has been completed.

In certain implementations, the indicator lines are provided by directing light through a countertop. The countertop thickness may be reduced to between one millimeter and two centimeters proximate to the indicator lines. The countertop may be inlaid with a transparent or translucent material proximate to the indicator lines.

### Example of a Processing Circuit

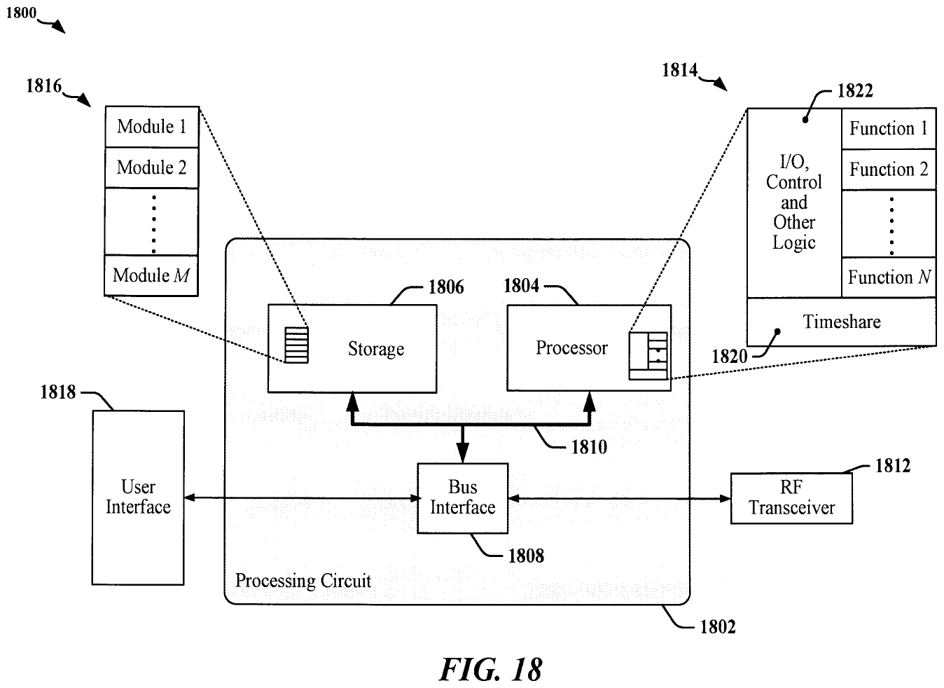

FIG. 18 is a diagram illustrating an example of a hardware implementation for an apparatus 1800 that may be incorporated in a charging device or in a receiving device that enables a battery to be wirelessly charged. In some examples, the apparatus 1800 may perform one or more functions disclosed herein. In accordance with various aspects of the disclosure, an element, or any portion of an element, or any combination of elements as disclosed herein may be implemented using a processing circuit 1802. The processing circuit 1802 may include one or more processors 1804 that are controlled by some combination of hardware and software modules. Examples of processors 1804 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1804 may include specialized processors that perform specific functions, and that may be configured, augmented or controlled by one of the software modules 1816. The one or more processors 1804 may be configured through a combination of software modules 1816 loaded during initialization, and further configured by loading or unloading one or more software modules 1816 during operation.

In the illustrated example, the processing circuit 1802 may be implemented with a bus architecture, represented generally by the bus 1810. The bus 1810 may include any number of interconnecting buses and bridges depending on the specific application of the processing circuit 1802 and the overall design constraints. The bus 1810 links together various circuits including the one or more processors 1804, and storage 1806. Storage 1806 may include memory devices and mass storage devices, and may be referred to herein as computer-readable media and/or processor-readable media. The storage 1806 may include transitory storage media and/or non-transitory storage media.

The bus 1810 may also link various other circuits such as timing sources, timers, peripherals, voltage regulators, and power management circuits. A bus interface 1808 may provide an interface between the bus 1810 and one or more transceivers 1812. In one example, a transceiver 1812 may be provided to enable the apparatus 1800 to communicate with a charging or receiving device in accordance with a standards-defined protocol. Depending upon the nature of the apparatus 1800, a user interface 1818 (e.g., keypad, display, speaker, microphone, joystick) may also be provided, and may be communicatively coupled to the bus 1810 directly or through the bus interface 1808.

A processor 1804 may be responsible for managing the bus 1810 and for general processing that may include the execution of software stored in a computer-readable medium that may include the storage 1806. In this respect, the processing circuit 1802, including the processor 1804, may be used to implement any of the methods, functions and techniques disclosed herein. The storage 1806 may be used for storing data that is manipulated by the processor 1804 when executing software, and the software may be configured to implement any one of the methods disclosed herein.

One or more processors 1804 in the processing circuit 1802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1806 or in an external computer-readable medium. The external computer-readable medium and/or storage 1806 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1806 may also include, by way of example, a carrier wave, a transmission line, and any other suitable medium for transmitting software and/or instructions that may be accessed and read by a computer. Computer-readable medium and/or the storage 1806 may reside in the processing circuit 1802, in the processor 1804, external to the processing circuit 1802, or be distributed across multiple entities including the processing circuit 1802. The computer-readable medium and/or storage 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1806 may maintain software maintained and/or organized in loadable code segments, modules, applications, programs, etc., which may be referred to herein as software modules 1816. Each of the software modules 1816 may include instructions and data that, when installed or loaded on the processing circuit 1802 and executed by the one or more processors 1804, contribute to a run-time image 1814 that controls the operation of the one or more processors 1804. When executed, certain instructions may cause the processing circuit 1802 to perform functions in accordance with certain methods, algorithms and processes described herein.

Some of the software modules 1816 may be loaded during initialization of the processing circuit 1802, and these software modules 1816 may configure the processing circuit 1802 to enable performance of the various functions disclosed herein. For example, some software modules 1816 may configure internal devices and/or logic circuits 1822 of the processor 1804, and may manage access to external devices such as a transceiver 1812, the bus interface 1808, the user interface 1818, timers, mathematical coprocessors, and so on. The software modules 1816 may include a control program and/or an operating system that interacts with interrupt handlers and device drivers, and that controls access to various resources provided by the processing circuit 1802. The resources may include memory, processing time, access to a transceiver 1812, the user interface 1818, and so on.

One or more processors 1804 of the processing circuit 1802 may be multifunctional, whereby some of the software modules 1816 are loaded and configured to perform different functions or different instances of the same function. The one or more processors 1804 may additionally be adapted to manage background tasks initiated in response to inputs from the user interface 1818, the transceiver 1812, and device drivers, for example. To support the performance of multiple functions, the one or more processors 1804 may be configured to provide a multitasking environment, whereby each of a plurality of functions is implemented as a set of tasks serviced by the one or more processors 1804 as needed or desired. In one example, the multitasking environment may be implemented using a timesharing program 1820 that passes control of a processor 1804 between different tasks, whereby each task returns control of the one or more processors 1804 to the timesharing program 1820 upon completion of any outstanding operations and/or in response to an input such as an interrupt. When a task has control of the one or more processors 1804, the processing circuit is effectively specialized for the purposes addressed by the function associated with the controlling task. The timesharing program 1820 may include an operating system, a main loop that transfers control on a round-robin basis, a function that allocates control of the one or more processors 1804 in accordance with a prioritization of the functions, and/or an interrupt driven main loop that responds to external events by providing control of the one or more processors 1804 to a handling function.

In some examples, the apparatus 1800 is included in, or operates as a wireless charging system that has a battery charging power source coupled to a charging circuit, a plurality of charging cells and one or more processors 1804. The plurality of charging cells may be configured to provide one or more charging surfaces that may be physically separated. At least one coil may be configured to direct an electromagnetic field through a charge transfer area of each charging cell. In one example, the charging system includes a wireless charging device and is embedded in or attached to a countertop, table, desk, workbench, bar top, kitchen worksurface, or other item of furniture that has a surface capable of maintaining in place a device to be charged. The wireless charging device includes a plurality of transmitting coils, at least one light source and a controller. The plurality of transmitting coils is typically arranged in a pattern on one or more charging devices. The plurality of transmitting coils may define the area or limits of a charging surface located within an upper surface of a countertop. Each light source may be provided below the countertop and may be configured to illuminate an indicator line that identifies a physical location of the charging surface. The indicator line appears on the upper surface of the countertop. In one example, light emitted by the light source travels through the countertop to illuminate the indicator line. The controller may be electrically and/or communicatively coupled to one or more printed circuit boards in the wireless charging device and may be configured to control light emissions by the light source. In some example, the controller is provided on the processing circuit 1802 and the processing circuit 1802 powers the light source.

In certain examples, light emitted by the light source travels through a hole formed in a lower surface of the countertop to illuminate the indicator line. The hole may be at least partially filled with a transparent, semitransparent, translucent or diaphanous material. In some instances, a light pipe, a light guide or light diffuser is inserted in the hole. The hole may terminate short of the upper surface of the countertop or may be a through-hole.

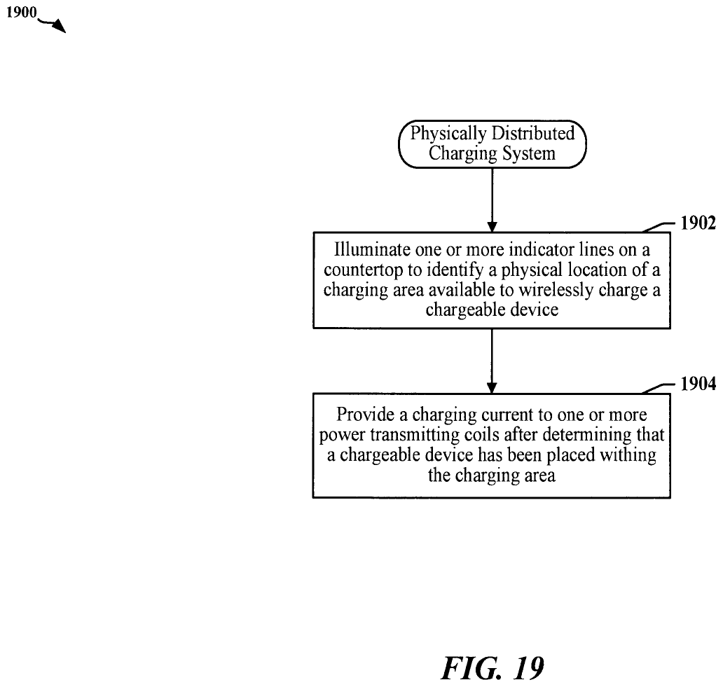

FIG. 19 is flowchart 1900 illustrating one example of a method for wireless charging. The method may be performed by a processor 1804 in a processing circuit 1802 illustrated in FIG. 18. The method may be performed using a main or primary controller 1302 or 1402. The wireless charging may be performed through a charging surface 1702 provided on a countertop 1700. At block 1902, the processor 1804 may be configured to illuminate one or more indicator lines 1704 on the countertop 1700 to identify a physical location of a charging area available to wirelessly charge a chargeable device. In one example, the charging area corresponds to the charging surface 1702 illustrated in FIG. 17. At block 1904, the processor 1804 may be configured to cause a charging current to be provided to one or more power transmitting coils after determining that a chargeable device has been placed within the charging area.

In some implementations, the increasing a rate or frequency at which searches for chargeable devices are conducted after illuminating the one or more indicator lines.

In some examples, the processor 1804 may configure a first color for the indicator lines to indicate a charging area that is available for charging the chargeable device, configure a second color for the indicator lines to indicate the charging area is being used for charging the chargeable device, and configure a third color for the indicator lines to indicate that charging the chargeable device has been completed.

In some examples, the processor 1804 may configure a first sequence of color changes for the indicator lines to indicate a charging area that is available for charging the chargeable device, configure a second sequence of color changes for the indicator lines to indicate the charging area is being used for charging the chargeable device, and configure a third sequence of color changes for the indicator lines to indicate that charging the chargeable device has been completed.

In certain implementations, the indicator lines are provided by directing light through the countertop. The countertop may have a thickness proximate to the indicator lines of between one millimeter and two centimeters. The countertop may be inlaid with a transparent or translucent material proximate to the indicator lines.

Some implementation examples are described in the following numbered clauses:
1. A wireless charging device, comprising: a plurality of transmitting coils arranged in a pattern that defines a charging surface located within an upper surface of a countertop; a light source provided below the countertop and configured to illuminate an indicator line that identifies a physical location of the charging surface; and a controller that is configured to control light emissions by the light source.
2. The wireless charging device as described in clause 1, wherein the indicator line appears on the upper surface of the countertop.
3. The wireless charging device as described in clause 1 or clause 2, wherein light emitted by the light source travels through the countertop to illuminate the indicator line.
4. The wireless charging device of claim 1, wherein light emitted by the light source travels through a hole formed in a lower surface of the countertop to illuminate the indicator line.
5. The wireless charging device as described in clause 4, wherein the hole terminates short of the upper surface of the countertop.
6. The wireless charging device as described in clause 4, wherein the hole is a through-hole.
7. The wireless charging device as described in any of clauses 4-6, wherein the hole is at least partially filled with a transparent, semitransparent, translucent or diaphanous material.
8. The wireless charging device as described in any of clauses 4-7, wherein a light pipe, a light guide or light diffuser is inserted in the hole.
9. The wireless charging device as described in any of clauses 4-7, wherein a portion of the light source is inserted in the hole.
10. A method for wireless charging, comprising: illuminating one or more indicator lines on a countertop to identify a physical location of a charging area available to wirelessly charge a chargeable device; and providing a charging current to one or more power transmitting coils after determining that a chargeable device has been placed within the charging area.
11. The method as described in clause 10, further comprising: increasing a rate at which searches for chargeable devices are conducted after illuminating the one or more indicator lines.
12. The method as described in clause 10 or clause 11, further comprising: configuring a first color for the indicator lines to indicate a charging area that is available for charging the chargeable device; configuring a second color for the indicator lines to indicate the charging area is being used for charging the chargeable device; and configuring a third color for the indicator lines to indicate that charging the chargeable device has been completed.
13. The method as described in clause 10 or clause 11, further comprising: configuring a first sequence of color changes for the indicator lines to indicate a charging area that is available for charging the chargeable device; configuring a second sequence of color changes for the indicator lines to indicate the charging area is being used for charging the chargeable device; and configuring a third sequence of color changes for the indicator lines to indicate that charging the chargeable device has been completed.
14. The method as described in any of clauses 10-13, wherein the indicator lines are provided by directing light through the countertop.
15. The method as described in any of clauses 10-14, wherein the countertop has a thickness proximate to the indicator lines of between one millimeter and two centimeters.
16. The method as described in any of clauses 10-15, wherein the countertop is inlaid with a transparent or translucent material proximate to the indicator lines.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A wireless charging device, comprising:
a plurality of transmitting coils arranged in a pattern that defines a charging surface located within an upper surface of a countertop;
a light source provided below the countertop and configured to illuminate an indicator line that identifies a physical location of the charging surface; and
a controller electrically that is configured to control light emissions by the light source.

2. The wireless charging device of claim 1, wherein the indicator line appears on the upper surface of the countertop.

3. The wireless charging device of claim 1, wherein light emitted by the light source travels through the countertop to illuminate the indicator line.

4. The wireless charging device of claim 1, wherein light emitted by the light source travels through a hole formed in a lower surface of the countertop to illuminate the indicator line.

5. The wireless charging device of claim 4, wherein the hole terminates short of the upper surface of the countertop.

6. The wireless charging device of claim 4, wherein the hole is a through-hole.

7. The wireless charging device of claim 4, wherein the hole is at least partially filled with a transparent, semitransparent, translucent or diaphanous material.

8. The wireless charging device of claim 4, wherein a light pipe, a light guide or light diffuser is inserted in the hole.

9. The wireless charging device of claim 8, wherein a portion of the light source is inserted in the hole.

10. A method for wireless charging, comprising:
illuminating one or more indicator lines on a countertop to identify a physical location of a charging area available to wirelessly charge a chargeable device; and
providing a charging current to one or more power transmitting coils after determining that a chargeable device has been placed within the charging area.

11. The method of claim 10, further comprising:
increasing a rate at which searches for chargeable devices are conducted after illuminating the one or more indicator lines.

12. The method of claim 10, further comprising:
configuring a first color for the indicator lines to indicate a charging area that is available for charging the chargeable device;
configuring a second color for the indicator lines to indicate the charging area is being used for charging the chargeable device; and
configuring a third color for the indicator lines to indicate that charging the chargeable device has been completed.

13. The method of claim 10, further comprising:
configuring a first sequence of color changes for the indicator lines to indicate a charging area that is available for charging the chargeable device;
configuring a second sequence of color changes for the indicator lines to indicate the charging area is being used for charging the chargeable device; and
configuring a third sequence of color changes for the indicator lines to indicate that charging the chargeable device has been completed.

14. The method of claim 10, wherein the indicator lines are provided by directing light through the countertop.

15. The method of claim 14, wherein the countertop has a thickness proximate to the indicator lines of between one millimeter and two centimeters.

16. The method of claim 14, wherein the countertop is inlaid with a transparent or translucent material proximate to the indicator lines.
